(19) United States
(12) Patent Application Publication
(10) Pub. No.: US 2006/0089850 A1
(43) Pub. Date: Apr. 27, 2006

(54) Method of conducting a blackjack-like game

(76) Inventors: Shenli Ko, Las Vegas, NV (US); Kenneth Brunelle, Las Vegas, NV (US)

Correspondence Address: Morishita Law Firm, L.L.C., Suite 850, 3800 Howard Hughes Pkwy., Las Vegas, NV, 89109, US

(21) Appl. No.: 11/247,116

(22) Filed: Oct. 5, 2005

Related U.S. Application Data
(63) Continuation-in-part of application No. 10/974,112, filed on Oct. 27, 2004.

(51) Int. Cl. G06Q 99/00

(52) U.S. Cl. 705/1

(57) ABSTRACT

The player places an initial wager and a target sum game, such as blackjack, is played by dealing an initial hand to the player and at least one card to a dealer. If the player has obtained a qualifying initial hand, the player is rewarded according to a pay table based on at least the composition of the initial player hand. In an optional embodiment, the pay table may also be based on the dealer card.

### RELATED APPLICATION DATA

The present application is a continuation-in-part of U.S. patent application Ser. No. 10/974,112 entitled “2 Thru 6 Blackjack Main Bet” filed Oct. 27, 2004 by Applicants herein.

### FIELD OF THE INVENTION

The present invention relates to card games. Specifically, the present invention is an improved method for conducting a card game, such as blackjack, where pay outs on certain winning hands are determined according to a pay schedule rather than being uniform.

### BACKGROUND OF THE INVENTION

The game of blackjack is one of the most popular card games, generally, and casino card games, specifically, in the world. The plurality, if not the majority, of table games in most, if not all, casinos around the world, are dedicated to the play of blackjack. Even though blackjack does not offer the most generous house advantage, the popularity of the game is an important factor to the casino in the distribution of floor space.

Blackjack is a card game played between one or more players and a dealer, also known as the house. In the standard game, the player first indicates his game wager, and then cards are dealt. Cards are dealt at random from one or more decks of playing cards. Commonly, cards are dealt from a shoe containing multiple standard decks of playing cards. In one variation, specific cards have been removed from the deck, e.g. all tens.

Once each player has placed a game wager, the dealer deals two cards to each player. In some games, the player's cards are dealt face down; in others they are dealt face up. Generally, the distinction is based on the number of decks used to conduct the game. When played with one or two decks, the player's cards are generally dealt face down. When played with more decks, the player's cards are generally dealt face up. The difference is based on the idea that, when there are fewer cards available, revealing just a few more cards to a card counter can make a large difference, but when there are more undealt cards remaining in the shoe, this advantage is minimized.

The dealer is also dealt a hand of cards. In many cases, the dealer is dealt two playing cards. In one version, the dealer's cards are dealt with one face-down (commonly referred to as the hole card) and one face-up (commonly referred to as the up card), so that the players can see one, but not both, of the dealer's cards before they must make any game choices. The hole card is generally not revealed until after each player completes his or her hand. In some casinos, most of which are outside of the United States, the dealer does not receive the second card until each player has completed his or her hand.

Blackjack hands are evaluated by totaling the point value of the constituent cards. Cards between two and ten, inclusive, are counted as their face value; picture cards (jack, queen, king) are counted as ten; Aces are counted as either one or eleven, whichever makes a better hand for the holder. The objective of the game is to have a hand valued closer to, but not greater than, twenty-one than opponent's hand is. The ideal hand is made up of an ace and a picture card or ten, with a value of twenty-one. This is known as a blackjack, a natural, or a traditional blackjack.

If the player has a blackjack, he or she wins immediately, unless the dealer also has a blackjack. In the traditional game, such a win is paid at odds of three-to-two (or in some newer implementations, six-to-five). If the dealer has a blackjack, those players not having a blackjack lose immediately. In most implementations, if both player and dealer have a blackjack, the result is a push, that is, a tie in which the player does not win, but does keep the initial wager.

If neither the player nor the dealer has a blackjack, the player may select one of several options. The player may stand, that is, play the hand as currently constituted; the player may hit, that is, receive one or more additional cards in an attempt to improve his or her hand total; the player may double down, that is, double the initial wager and receive one additional card; or, if the player started with two cards of the same value, the player may split the cards to create two hands, each beginning with one of the pair of cards which had constituted the player's initial hand. Each of the split hands would receive an additional card to create two new initial two-card hands, each of which would then be completed using the same options (although some casinos have some limits on doubling down after a split and splitting after a split). In some casinos, the player may also have the right to surrender, that is, concede defeat and forfeit a portion of the initial wager. The player may continue to make choices until the player does one of the following: stand; double-down; surrender; or bust by obtaining a hand value that exceeds twenty-one. In the case of a bust, the player automatically loses. In the remaining cases, the player must wait until the dealer constitutes his or her hand to determine whether the player wins or loses.

If any players remain in the game, the dealer constitutes his or her final hand by hitting or standing. Typically, house rules dictate whether the dealer hits or stands. That is, the dealer hits until the dealer has a hand value dictated by the house rules. In the event that the dealer's hand value exceeds twenty-one, the dealer busts, and all players remaining in the game automatically win.

Player hands are compared to the dealer hand and the target value of twenty-one. If the player hand value is closer to the target value of twenty-one than the dealer hand value is, the player wins and is rewarded with an amount equal to the player's initial wager. If the dealer hand value is closer to the target value of twenty-one than the player hand value is, the player loses and the dealer collects the player's initial wager. If the dealer hand value is equal to the player hand value, the hand is a push and the player neither wins nor loses.

Blackjack's popularity is based on the simplicity of the underlying game and the relatively low house advantage. In fact, there exist card counting systems believed to eliminate the house advantage and bring the advantage to the player. Because blackjack hands are typically rewarded at 3:2, it is possible for card counting systems to beat the game. Thus, many casinos have adopted a policy where blackjack hands are rewarded at 6:5 or 1:1 (even money) to thwart card counting. However, these types of rule changes can raise the house advantage from about 0.5% for a game in which blackjack hands are paid at 3:2 to 1.5% or more for a game in which blackjacks are paid at 6:5 or even money. This hurts the majority of blackjack players who do not count cards.

Also, the 3:2 and 6:5 reward for a blackjack is an operational problem for the casino. It means that a supply of smaller-value chips must be maintained solely to pay the fractional pay outs for blackjack hands. This also translates to extra time computing, and paying, the awards for initial wagers which do not produce an integer award when multiplied. For example, a $5.00 wager for which a blackjack hand is dealt must be paid $7.50. A $7.50 wager would expect $11.25, but there are no $0.25 chips. Most casinos try to get wagers to even amounts, and automatically reject any $0.25 rewards (including reducing $0.75 to $0.50). Dealers are also more prone to error when paying blackjacks in unusual amounts. It would be advantageous to make reward ratios integer numbers.

A number of variations on blackjack have been developed. For example, U.S. Pat. No. 5,979,897 discloses a variation of blackjack in which a player blackjack in a specified suit pays 2:1 whereas all other blackjacks pay 1:1. Also, the player may place a side bet on receiving a blackjack in a designated suit for a potential pay out of 300:1.

Similarly, U.S. Pat. No. 6,293,551 discloses a blackjack game that provides a player insurance betting option when a dealer first card is either an ace or a ten-value card. A player may also bet on whether the player will obtain a natural twenty-one when the first card dealt to a player is either an ace or a ten-value card. Pay outs for the respective bets are varied according to whether the dealer or player first card is the ace or the ten-value card and whether the natural twenty-one is comprised of cards of a predefined relation such as same suit or color or cards including a 10-value card of a particular rank.

Similarly, U.S. Pat. No. 6,371,867 discloses a game that combines the play of blackjack with a 3-card Poker side wager (“21+3”). Each player places a primary blackjack wager and an optional 3-card Poker wager before the cards are dealt. Each player is dealt two cards with one of the dealer's cards being dealt face-up. The outcome of each 3-card Poker hand is determined, where a 3-card Poker hand consists of the 2-card hand dealt to that player and the dealer's face-up card.

Similarly, U.S. Pat. No. 6,422,565 discloses a method of playing a blackjack variation in which the dealer, instead of hitting his hand until it is 17 or greater, will hit until his hand beats the player's or busts. A player's blackjack is paid 1:1 unless it is suited, in which case it is paid 2:1. As a consequence, the player's expected return for blackjacks is less than the 3:2 return that conventional blackjack yields.

Finally, U.S. Pat. No. 6,604,741 discloses a method of playing a blackjack variation wherein a player's blackjack is paid 1:1, except where a player receives a suited blackjack, which is paid at a rate of greater than 1:1. As a consequence, the player's expected return for blackjacks is less than the 3:2 return that conventional blackjack yields.

In each of these blackjack variations, the game either requires the player to make an additional bet or introduces more liberal rules to entice more play, such as doubling down on two or more cards, surrender after doubling down and a 6-card automatic winner. However, these liberal rules do not come without a price. As the house advantage on traditional blackjack is very low, typically between 0.2% and 0.6%, player blackjacks must be paid even money instead of 3:2 to compensate for the loss of the casino's advantage due to the liberal rules. The probability of getting an uncontested blackjack is about 4.6%. By paying 1:1 instead of 3:2 on a player blackjack, the house gets an additional 2.3% advantage. For every four blackjacks dealt there will be one suited blackjack and for every 16 blackjacks dealt there will be one blackjack of a specific suit, e.g., diamonds. While paying 2:1 for a suited blackjack reduces the house's additional 2.3% advantage by half, paying 2:1 for a blackjack of a specific suit only reduces it by one-eighth. So, despite the liberal rules added, these blackjack variations still have a higher house advantage than traditional blackjack. Additionally, these games fail to address the use of card counting systems or, if they do, use conventional means to counter card counting systems that hurt the majority of the players who do not count cards.

As alluded to above, traditional 3:2 blackjack, unfortunately, helps make card counting more lucrative. That is, a card counter tracks the relative ratios of cards remaining to be dealt so that the player can raise his bet when the remaining deck is in his favor and reduce his bet when it is in the house's favor. That is, when the deck is rich in high cards, the player has the advantage because: (a) player blackjacks are paid at 3:2, (b) the dealer must hit to a predetermined sum, whereas the player can stand on any sum, and (c) the player has the option to double down and split to increase the player's stake in a game in which the player is likely to win.

Therefore, it can be seen that there is a need in the art for an improved method of conducting a blackjack game.

### SUMMARY OF THE INVENTION

An improved method for conducting a card game played between a dealer and at least one player utilizing playing cards. According to the present card game, jacks, queens, and kings are counted as ten, aces are counted as one or eleven, and all other cards are counted as face value. Each player makes an initial wager and the dealer randomly distributes an initial hand of two cards to each player. The dealer also distributes at least one card to himself or herself.

A pay table is defined for qualifying initial hands. A pay table is defined for one or more of the qualifying initial hands, so that the player's reward, if any, is based on whether the player obtains a qualifying initial hand. In one optional embodiment, qualifying initial hands include traditional blackjack hands, which are hands comprising an initial player hand of one ace and one ten-value card. According to the present invention, the composition of a traditional blackjack hand is defined by at least one of the suit of the ace, the suit of the ten-value card, and the rank of the ten-value card, although additional factors could be considered in an optional embodiment. The pay table includes at least two different pay outs for traditional blackjack hands such that a player is rewarded a first payout for obtaining a traditional blackjack when the initial player hand has a first composition and a second payout different from the first payout for obtaining a traditional blackjack when the initial player hand has a second composition. In an optional embodiment, the first payout may be greater than even money and the second payout may be even money.

For example, in an optional embodiment, the first composition includes suited ace and ten-value card combinations and the second composition includes non-suited ace and ten-value card combinations. Similarly, in an optional embodiment, the first composition includes ace and ten-value card combinations in which the colors of the suits match and the second composition includes ace and ten-value card combinations in which the colors of the suits do not match. In yet another optional embodiment, the ten-value cards are divided into a first subset and a second subset, and the first composition comprises initial player hands in which the ten-value card is from the first subset and the second composition comprises initial player hands in which the ten-value card is from the second subset. As shown in these examples, in an optional embodiment, the first composition and second composition may be mutually exclusive.

In an optional embodiment, the pay table may additionally include pay outs based on the dealer card in combination with the composition of the player hand. In such an optional embodiment, a first composition and a second composition of initial player hands, and a first set and a second set of dealer cards, such that the first combination and second combination are defined by selecting one of the first composition or second composition and one of the first set or second set. In such an optional embodiment, a first set could include the cards ace, seven, eight, nine, ten, jack, queen, and king, and the second set comprises the cards two, three, four, five and six.

The initial player hand is examined for a traditional blackjack hand. If the player has a traditional blackjack, the player is rewarded according to the pay table and the player initial wager. For each player not having a traditional blackjack hand, the player forms a final hand according to the conventional rules of blackjack. The dealer likewise forms a final hand. Optionally, the dealer forms a final hand by receiving additional cards until the sum of the dealer's cards is seventeen or greater. In a further optional embodiment, the dealer may receive no more than three additional cards without regard to the sum of the dealer cards.

### BRIEF DESCRIPTION OF THE DRAWINGS

FIG. 1 is a top view of a playing table surface according to an embodiment of the present invention;

FIG. 2 is a flow chart of a method for conducting an improved blackjack game according to an embodiment of the present invention.

### DESCRIPTION

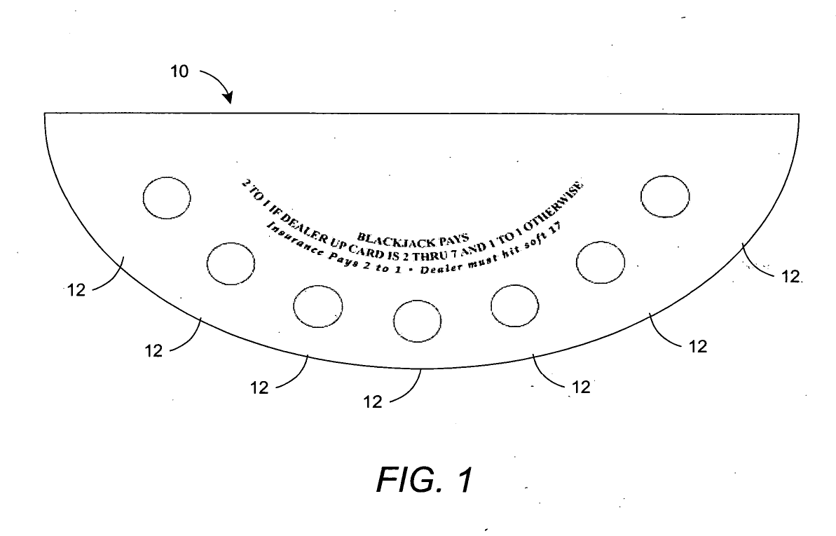

Reference is now made to the figures wherein like parts are referred to by like numerals throughout. The present invention may be incorporated into any embodiment of blackjack or similar target value game in which the object of the game is to obtain a hand that is closer to a target value than a dealer hand or, in a variation thereon, an opposing player hand, is. As shown in FIG. 1, the present game may be played on a playing surface 10 with a plurality of player positions 12. The playing surface 10 may include a display of one or more prespecified pay tables (not shown), although this is not necessary to the present invention.

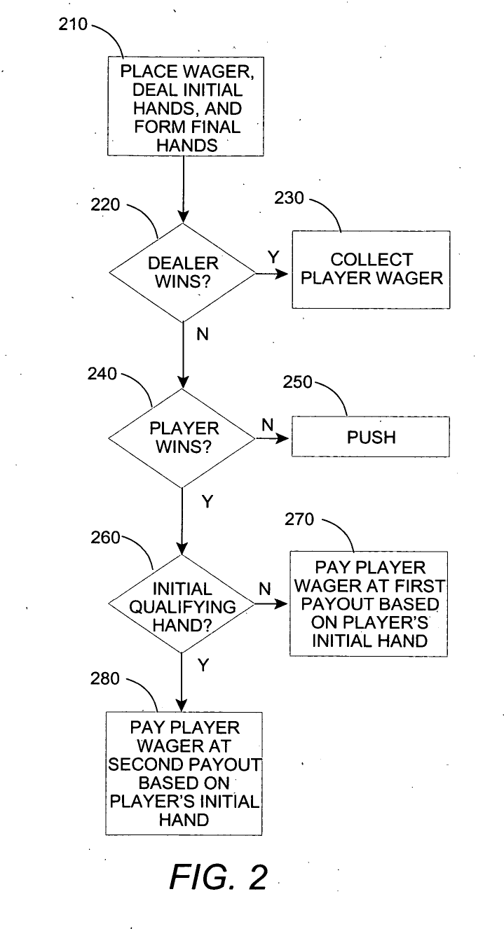

Referring specifically to the method as illustrated in FIG. 2 and the pay tables described below, the pay tables define pay outs and pay rates for a player obtaining a qualifying initial hand. That is, the pay out or pay rate for a player is determined by the player's initial hand, alone or in combination with one or more of the dealer cards. Thus, even if the player does not find out whether the player will be rewarded 270, 280 until a final hand is formed, the pay rate or pay out for which player is eligible is determined 260, at least in part, by the player initial hand. Thus, if the player obtains a qualifying initial hand 260, or a qualifying combination in another embodiment described in greater detail below, the player is eligible to be rewarded 280 at a first pay rate, or receive a first pay out, whereas if the player does not obtain a qualifying initial hand, or a qualifying combination, the player is eligible to be rewarded at a second pay rate 270, or receive a second pay out, different from the first pay rate or first pay out, respectively.

While the qualifying initial hands could take any form, in an optional embodiment, qualifying initial hands include traditional blackjack hands, also known as natural blackjack hands, of an ace and a ten-value card. That is, when the player obtains an initial player hand that is a traditional blackjack, the pay out to the player may be determined according to the pay tables. In one optional embodiment, the pay tables are based on the initial player hand composition. In such an optional embodiment, the initial player hand composition could be determined by many different factors, such as the suit of the ace, the suit of the ten-value card, the rank of the ten-value card, and any other factor characterizing the initial player hand composition.

For example, in an optional embodiment, the pay table shown in Table 1 could be used. In this optional embodiment, the pay out for a traditional blackjack is determined by whether the suit of the ace matches the suit of the ten-value card.

TABLE 1

| Blackjack Composition | Pay Out |
|---|---|
| Suited Blackjacks | 3 to 1 |
| Non-suited Blackjacks | 1 to 1 |

In another example, the pay table shown in Table 2 could be used. In this optional embodiment, the pay out for a traditional blackjack is determined by whether the color of the suit of the ace matches the color of the suit of the ten-value card.

TABLE 2

| Blackjack Composition | Pay Out |
|---|---|
| Matching Suit Color Blackjacks | 2 to 1 |
| Non-matching Suit Color Blackjacks | 1 to 1 |

In yet another example, the pay table shown in Table 3 could be used. In this optional embodiment, the pay out for a traditional blackjack is determined by the rank of the ten-value card. In this example, the ten-value cards are divided among two subsets, such that an ace combined with a ten-value card from one subset is paid at a different rate than an ace combined with a ten-value card from another subset.

TABLE 3

| Blackjack Composition | Pay Out |
|---|---|
| Ace Combined With King | 3 to 1 |
| Ace Combined With Other Ten-Value Cards | 1 to 1 |

It is noted that these pay tables are exemplary only and do not preclude the use of alternative or additional compositions or pay outs. In fact, it is contemplated that the pay out for a player blackjack could be adjusted in any number of ways. In one optional embodiment, the pay out for player blackjacks could be determined by: (a) selecting any two of the following three variables: (1) the expected return percentage, (2) a selected card composition of a player's blackjack to modify the established 3:2 payoff, (3) an adjusted payoff equal to or greater than zero to pay to a player; (b) from the two selected variables, determining the third variable according to the following formula: E(R)=P(B₁)*W₁+P(B₂)*W₂, where E(R) is the expected return percentage, P(B₁) is the probability of the player receiving a blackjack having the selected composition, W₁ is the pay out for the selected composition, P(B₂) is the probability of the player receiving any other blackjack and W₂ is its payoff, and (c) playing the game of blackjack according to the game operator's rules and paying the player the adjusted pay out when the player receives a blackjack matching the selected composition. It is noted that such a method is exemplary only, and does not preclude other methods for varying or adjusting blackjack pay outs.

As is understood in conventional blackjack, in one optional embodiment, a push occurs, and the player's wager is returned 250, if both the player and the dealer have a blackjack. However, this should not preclude the application of the present invention to an optional embodiment in which either the player wins 270, 280 or the dealer wins 220 in the event that both have a blackjack.

In yet a further optional embodiment, additional factors may be used to determine the pay out for a player blackjack hand. For example, in an optional embodiment, a pay table is defined in which the combination of the initial player hand composition and one or both of the cards in the dealer's hand determine the hand pay out. As noted above, the initial player hand composition could take many different forms. Similarly, the use of the exposed dealer card could take many different forms. For example, in one optional embodiment, a first set of dealer cards and second set of dealer cards are defined. For example, in an optional embodiment, the first set of dealer cards could include ace, seven, eight, nine, ten, jack, queen, and king and the second set of dealer cards could include two, three, four, five and six. In such an optional embodiment, various combinations of dealer card and initial player hand composition could be rewarded differently.

For example, in one optional embodiment, the pay out may be computed by:
Reward Paid=Initial Wager*R1*R2 where

R1=Reward factor as determined based on player hand configuration, and

R2=Reward factor as determined based on dealer up card.

To conduct the present game, the player places an initial wager and cards are dealt 210. More specifically, once initial wagering is complete, the player receives an initial player hand of two cards and the dealer receives at least one card. The procedure in dealing the dealer cards is not significant to the present game. Thus, in one optional embodiment, the dealer may receive two cards, one face-up and one face-down, when the players receive their hands; in another optional embodiment, the dealer may receive one card when the players receive their hands and a second card after all players complete their hands; and the like. It is contemplated that the present invention may be applied to a game in which multiple decks are used, a single deck is used, or a subset of a deck is used. Additionally, the word “deck” specifically includes standard decks, i.e. thirteen cards in four suits, but also supplemented standard decks, i.e. decks with additional cards, and reduced decks such as Spanish decks that have the ten-spot cards removed.

In one optional embodiment, the player hands are inspected for qualifying initial hands 260. If any player has a qualifying initial hand the player is paid according to a different pay rate than if the player does not have a qualifying initial hand.

In another optional embodiment, the pay rate may be determined by a combination of the initial player hand and at least one of the dealer's cards. In such an optional embodiment, a player having a qualifying combination of an initial player hand and at least one of the dealer's cards is rewarded at a different pay rate than if the player does not have a qualifying combination.

For example, in one optional embodiment in which the qualifying initial hands include traditional blackjack hands comprising an ace and a ten-value card, the player is rewarded according to the defined pay tables described above. If the player does not have a qualifying initial hand, the dealer and player complete their hands and resolve wagers as in conventional blackjack.

As noted above, in an optional embodiment, games in which the player and dealer each receive a two-card hand comprising a traditional blackjack, the hand is a push 250 with player neither losing nor being rewarded. In an alternate optional embodiment, the player may win 240 on a push, and be rewarded, or may lose 230 on a push, and have his wager collected.

The player and dealer form final hands (which, in an optional embodiment applied to conventional blackjack, involves hitting, i.e. receiving additional cards, or standing, i.e. not receiving any additional cards, with the goal being to reach a target value of twenty-one without exceeding the target value). In an optional embodiment applied to blackjack in which traditional blackjack hands, i.e. an initial hand of a ten-value card plus an ace, is a qualifying hand, the initial hand is the final hand. Comparing the player hand to the dealer hand, and the target value, a determination is made whether the player loses 230, wins 240, or pushes 250. If the player wins, the player is rewarded. A player who wins 240 and had an initial hand that was not a qualifying initial hand 260 is rewarded 270 at a first rate, whereas a player who wins 240 and had an initial hand that was a qualifying initial hand 260 is rewarded 280 at a second rate, typically, though not necessarily, greater than the first rate.

In an optional embodiment, rewards according to the payoff table may be issued for prespecified player hands other than traditional blackjacks. In one such optional embodiment, qualifying initial hands may include player hands that have a particular composition based on such attributes as suit, color, rank, sum, or the like. For example, in one optional embodiment, the player is rewarded in accordance with a different pay table if the player is dealt an initial two-card hand totaling eleven. In another optional embodiment, qualifying initial hands may include consideration of one or both of the player's initial cards in combination with one or both of the initial dealer cards.

While certain embodiments of the present invention have been shown and described it is to be understood that the present invention is subject to many modifications and changes without departing from the spirit and scope of the claims presented herein.

I claim:

1. An improved method for conducting a card game played between a dealer and at least one player according to the conventional rules of blackjack utilizing playing cards, or electronic representations thereof, where Jacks, Queens, and Kings are counted as ten, Aces are counted as one or eleven, and all other cards are counted as face value, in which each player makes an initial wager, the dealer randomly distributes an initial player hand of two cards, or electronic representations thereof, to each player and at least one card, or electronic representation thereof, to the dealer, the improved method comprising the steps of:
defining a pay table, said pay table including at least two different pay rates depending upon at least the initial player hand such that a player is rewarded at a first pay rate if the player obtains a qualifying initial hand and a second pay rate different from said first pay rate if the player does not obtain a qualifying initial hand;
examining said initial player hand for a qualifying initial hand;
forming a final hand according to said conventional rules of blackjack;
determining whether any players have won a reward; and
issuing a reward, if any, to each player having a qualifying initial hand according to said first pay rate and said player's initial wager, and to each player not having a qualifying initial hand according to said second pay rate and said player's initial wager.

2. The method of claim 1 wherein said first initial hand includes at least one traditional blackjack hand comprising an initial player hand of one ace and one ten-value card.

3. An improved method for conducting a card game played between a dealer and at least one player according to the conventional rules of blackjack utilizing playing cards, or electronic representations thereof, where Jacks, Queens, and Kings are counted as ten, Aces are counted as one or eleven, and all other cards are counted as face value, in which each player makes an initial wager, the dealer randomly distributes an initial player hand of two cards, or electronic representations thereof, to each player and at least one card, or electronic representation thereof, to the dealer, the improved method comprising the steps of:
defining a pay table, said pay table including at least two different pay rates depending upon the initial player hand in combination with at least one of said dealer's cards, such that a player is rewarded at a first pay rate if the player obtains a qualifying combination of an initial player hand and at least one of said dealer's cards and a second pay rate different from said first pay rate if the player does not obtain a qualifying combination of an initial player hand and at least one of said dealer's cards;
examining said initial player hand for a qualifying initial hand;
forming a final hand according to said conventional rules of blackjack;
determining whether any players have won a reward; and
issuing a reward, if any, to each player having a qualifying combination according to said first pay rate and said player's initial wager, and to each player not having a qualifying initial hand according to said second pay rate and said player's initial wager.

4. The method of claim 3 wherein said qualifying combination includes an initial player hand of a traditional blackjack hand comprising an initial player hand of one ace and one ten-value card.

5. An improved method for conducting a card game played between a dealer and at least one player according to the conventional rules of blackjack utilizing playing cards, or electronic representations thereof, where Jacks, Queens, and Kings are counted as ten, Aces are counted as one or eleven, and all other cards are counted as face value, in which each player makes an initial wager, the dealer randomly distributes an initial hand of two cards, or electronic representations thereof, to each player and at least one card, or electronic representation thereof, to the dealer, the improved method comprising the steps of:
defining a pay table for traditional blackjack hands comprising an initial player hand of one ace and one ten-value card having a composition defined by at least one of the suit of the ace, the suit of the ten-value card, and the rank of the ten-value card, said pay table including at least two different pay outs for traditional blackjack hands such that a player is rewarded a first pay out for obtaining a traditional blackjack when the initial player hand has a first composition and a second payout different from said first payout for obtaining a traditional blackjack when the initial player hand has a second composition;
examining said initial player hand for a traditional blackjack hand;
rewarding each player having a traditional blackjack according to said pay table and said player's initial wager; and
for each player not having a traditional blackjack hand, forming a final hand according to said conventional rules of blackjack.

6. The method of claim 5 wherein said first composition and said second composition are mutually exclusive.

7. The method of claim 5 wherein said first composition comprises initial player hands in which the suit of the ace matches the suit of the ten-value card and said second composition comprises initial player hands in which the suit of the ace does not match the suit of the ten-value card.

8. The method of claim 5 wherein said first composition comprises initial player hands in which the color of the suit of the ace matches the color of the suit of the ten-value card and said second composition comprises initial player hands in which the color of the suit of the ace does not match the color of the suit of the ten-value card.

9. The method of claim 5 further comprising, defining a first subset and a second subset of said ten-value cards, said first subset and second subset mutually exclusive, such that said first composition comprises initial player hands in which the ten-value card is from said first subset and said second composition comprises initial player hands in which the ten-value card is from said second subset.

10. The method of claim 5 wherein said second payout is even money.

11. The method of claim 10 wherein said first payout is greater than even money.

12. An improved method for conducting a card game played between a dealer and at least one player according to the conventional rules of blackjack utilizing playing cards, or electronic representations thereof, where Jacks, Queens, and Kings are counted as ten, Aces are counted as one or eleven, and all other cards are counted as face value, in which each player makes an initial wager, the dealer randomly distributes an initial player hand of two cards, or electronic representations thereof, to each player and at least one card, or electronic representation thereof, to the dealer, the improved method comprising the steps of:
defining a pay table for traditional blackjack hands comprising an initial player hand of one ace and one ten-value card having a composition defined by at least one of the suit of the ace, the suit of the ten-value card, and the rank of the ten-value card, said pay table including at least two different pay outs for traditional blackjack hands based on at least two parameters of initial player hand composition and at least one dealer card such that a player is rewarded a first pay out for obtaining a traditional blackjack determined by a first combination of initial player hand composition and said at least one dealer card and a second payout different from said first pay out for obtaining a traditional blackjack determined by a second combination of initial player hand composition and said at least one dealer card;
examining said initial player hand for a traditional blackjack hand;
rewarding each player having a traditional blackjack according to said pay table and said player's initial wager; and
for each player not having a traditional blackjack hand, forming a final hand according to said conventional rules of blackjack.

13. The method of claim 12 further comprising defining a first composition and a second composition of initial player hands, and a first set and a second set of dealer cards, such that said first combination and second combination are defined by selecting one of said first composition or second composition and one of said first set or second set.

14. The method of claim 13 wherein said first composition comprises initial player hands in which the suit of the ace matches the suit of the ten-value card and said second composition comprises initial player hands in which the suit of the ace does not match the suit of the ten-value card.

15. The method of claim 13 wherein said first composition comprises initial player hands in which the color of the suit of the ace matches the color of the suit of the ten-value card and said second composition comprises initial player hands in which the color of the suit of the ace does not match the color of the suit of the ten-value card.

16. The method of claim 13 further comprising, defining a first subset and a second subset of said ten-value cards, said first subset and second subset mutually exclusive, such that said first composition comprises initial player hands in which the ten-value card is from said first subset and said second composition comprises initial player hands in which the ten-value card is from said second subset.

17. The method of claim 13 wherein said first set comprises a subset of the set of combinations of at least one of the playing cards being utilized.

18. The method of claim 13 wherein said subsets of said set of combinations constituting said first set and said second set are defined according to at least one of the numerical value of the cards, the suit of the cards, or the color of the suit of the cards.

19. The method of claim 13 wherein the intersection of said first set and said second set is null.
